(19) United States
(12) Patent Application Publication
(10) Pub. No.: US 2013/0265306 A1
(43) Pub. Date: Oct. 10, 2013

(54) Real-Time 2D/3D Object Image Composition System and Method

(71) Applicant: Greg D. Landweber, Rhinebeck, NY (US)

(72) Inventor: Greg D. Landweber, Rhinebeck, NY (US)

(73) Assignee: PENGUIN DIGITAL, INC., New York, NY (US)

(21) Appl. No.: 13/441,244

(22) Filed: Apr. 6, 2012

(51) Int. Cl. G06T 19/00

(52) U.S. Cl. CPC G06T 19/006
USPC 345/426; 345/419

(57) ABSTRACT

The present application relates to a system and method of creating composite images from 2-dimensional images and 3-dimensional object images in real-time. The method includes a user uploading a 2-dimensional image, applying various image manipulation parameters to the 2-dimensional image based on a 3-dimensional image. The disclosed method can operate in real-time and allows for any given 2-dimensional image or 3-dimensional object image. Final composite images show a manipulated 2-dimensional image on a 3-dimensional object image with the desired perspective, shadows, lighting, and proportion. This image is then viewable by a user through a screen.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The current invention generally related to systems and methods utilized for real-time rendering of 2D composite images through the use of multiple image layers and various 3D affine transformations.

### BACKGROUND OF THE INVENTION

There are various uses and examples where 2-dimensional (2D) images need to be visualized on 3-dimensional (3D) products or surfaces. Being able to quickly and effectively change the look of a 3D object or surface is an effective way to allow users to visualize how a 2D image would look on that object or surface. Many consumers wish to customize consumer products with their own images or image designs. This allows for creative use and creation of consumer products that appeal to more consumers in the marketplace.

Previous systems and methods of applying 2D images onto 3D objects and surfaces contained flaws that limited their utility and effectiveness. Prior systems did not take into account all elements connected with the visualization of a 3D object. Elements such as lighting, shadow, and positioning of the 3D object or surface are all important in creating a composite image that is accurate to the final product that a user wishes to customize. Prior systems also did not account for the unique 3D properties of a given object in order to create a composite image of a final product. Properties such as size, shape, and the various unique surface properties of a given object should be taken into account in order to properly visualize a 2D image or drawing unto a 3D object.

The current invention solves these issues through the use of multiple layers including shadows, 3D object images, 2D images or drawings, and lighting effects of the 3D product in order to create a composite image. This is done by applying the appropriate 3D affine transforms, projections, cylindrical distortions, and size modifications to a user's 2D image, resulting in a version of the user's photo with the same perspective as the 3D object image. When all the layers are composed together, the manipulated 2D image is masked to the 3D object image along with the appropriate lighting and shadows. This system and method ultimately provides a novel and unique marketing tool that allows for custom visualization of products by users through the creation of these composite images.

This system and method operates in real time in order to create composite images from any 2D image and 3D object image combination a user chooses. The system and method can operate on a variety of platforms (from computers to mobile environments), can be coded in any language and can operate within a variety of operating systems (including, but not limited to, iOS, Android, Windows, OSX, and Linux operating systems). Further, any device with image capture capabilities (such a mobile phone) can utilize the system once it is coded for that phone's particular operating system. This system and method can operate as a stand-alone application or it can be incorporated into other 3^{rd} party applications and provide the same functionality.

The particular 3D affine transformations and projections for a given product can either be hand coded into the system or based on translated coordinates through a unified 3D rendering engine or method. Either method will allow for the creation of the composite images based on any 3D object introduced into the system.

### SUMMARY OF THE INVENTION

This invention relates to real-time image processing systems and methods, particularly those systems and methods involving the use of 3D affine transformations, projections, cylindrical distortions, and multiple photographic layers to render multiple 2D images into composites with the desired perspective, shadows, lighting, and proportion. A user's 2D image is manipulated and then aligned with the 3D object image in order to create a composite image of the 2D images on the 3D object. This image is then viewable by a user through a screen.

### BRIEF DESCRIPTION OF THE DRAWINGS

The subject matter, which is regarded as the invention, is particularly pointed out and distinctly claimed in the claims at the conclusion of the specification. The foregoing and its features, along with advantages of the invention will be apparent from the following detailed description taken in conjunction with the accompanying drawings:

FIG. 1 is a schematic illustrating the process by which the invention enables the real-time composite image creation.

FIG. 2 is a visual example of the process of taking a user's 2D image, along with the additional 3D object image and layers in order to create the composite image.

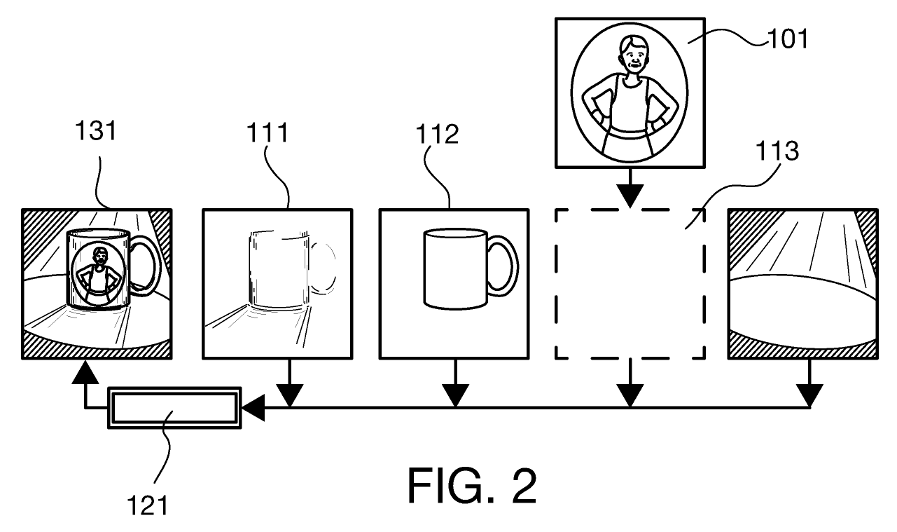

FIG. 3 is a visual representation of a final composite image reproduced on a screen after completion of the method described herein.

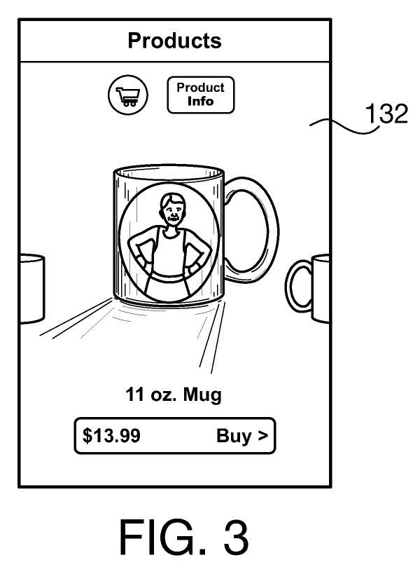

### DETAILED DESCRIPTION OF THE INVENTION

It should be understood that this embodiment is only one example of the many possible forms that the invention can use. In general, statements made in the specification of the present application do not necessarily limit any of the claims of the invention. Moreover, some statements may apply to some inventive features but not to others. In general, unless otherwise indicated, singular statements may be in the plural and vice-versa with no loss of generality.

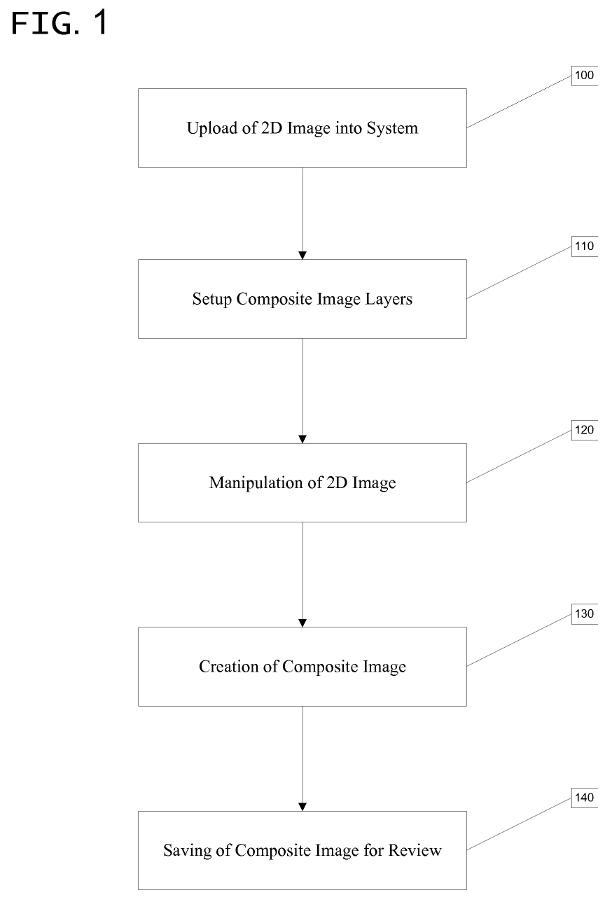

The invention presented in FIG. 1 is a schematic illustrating the process by which the invention enables real-time composite image creation. The steps substantially taken in order to create the composite images can be divided into step 100 for uploading the user's 2D image file 101, step 110 for setup of the composite image layers, step 120 for manipulation of the user's 2D image, step 130 for creation of the composite image, and step 140 for saving of the composite image for review.

### Uploading Image Files

The system and method within FIG. 1 begins with step 100, which comprises uploading a 2D image file 101 into the system. This 2D image file generally refers to standard 2D files that the user wishes to visualize unto a given 3D object. Image file formats include those with extensions such as JPEG, EXIF, TIFF, RAW, PNG, GIF, and BMP but are not limited to these file formats.

The 2D image may be accessed by or transferred into the system through a variety of methods. All of these methods generally will be referred to as “uploading” into the system. The 2D image file 101 can be uploaded from a variety of sources that are programmed into the system for access. Local storage can be physical memory that is connected or incorporated into any given device that utilizes the system. A cloud-based storage solution can also be used to access any uploaded image files from storage that is remotely connected, usually through a wired or wireless network connection. Devices with image capture components (such as mobile phones, laptops, tablets, or smart cameras) can also capture an image and directly forward the image into the system. The above sources are not meant to be exclusive as the system can accommodate accessing any source for uploading a user's image.

### Setup of Image Layers for Creation of Composite Images

Step 110 comprises the setup of the composite layers needed within the system. To render the user's 2D images onto a 3D object, the system requires four image layers to create the final composite image. These image layers are a shadow layer 111, the 3D object layer 112, a 2D image layer 113, and a lighting effects layer 114.

The shadow layer 111 contains an image of the shadows that normally appear when a 3D object is photographed. This layer is usually pre-processed based on photographs of production models of a 3D object in order to give the composite an accurate representation of the shadows in a lighted space. In alternate embodiments, multiple shadow layers may be alternated by the system in real-time in order to allow the user additional perspectives and composite images processed by the system.

The 3D object layer 112 is an image of the 3D object by itself that the user wishes to have their 2D image 101 applied to. The set of image manipulation parameters used by the system within step 120 is based on this 3D object image.

The 2D image layer 113 is user's manipulated 2D image 101 within the composite. The system processes the user's 2D image 101 (based on step 120 taken below) in order to place the 2D image 101 within this layer of the final composite image 131.

The lighting layer 114 contains an image of the lighting that is used when a 3D object is photographed. This layer is usually pre-processed based on photographs of production models of a 3D object in order to give the composite an accurate representation that includes the expected lighting on the object by the user. In alternate embodiments, multiple lighting layers may be alternated by the system in real-time in order to allow the user additional perspectives of the composite processed by the system.

### Manipulation of the User's 2D Image

Step 120 involves preparing the user's 2D image 101 as a layer within the final composite image 131 by applying the appropriate image manipulation parameters based on the 3D object image chosen by the user for visualization. This includes 3D affine transforms, projections and in some cases a cylindrical distortion to the user's 2D image 101, resulting in a version of the user's image with the same perspective as the original photo on the product. The system will also adjust the 2D image's size and positioning in order to properly align the 2D image and 3D object layers.

The system can either have pre-coded manipulation parameters for each 3D object image that is selectable by a user or the system can contain a unified engine that generates the manipulation parameter for any 3D object image in real-time. A rendering engine 121 would specify such things as (1) the particular images that will be used for layers 111, 112, 113, and 114; (2) the particular type of image manipulation parameter applied and any data in connection with the object selected (height, radius, and tilt for a cylindrical distortion versus coordinates for a 3D perspective affine transformation); and (3) any possible instance data for multiple products within a given selection by a user. The difference between pre-coded manipulation parameters versus use of the rendering engine 121 is that the rendering engine allows for abstraction of the geometry needed for a given 3D object. This abstraction allows for a more streamlined conversion of the method for other software platforms, but is not necessary if the method is intended for only one particular software environment. Regardless of the rendering method chosen the final composite image 131 should be the same regardless of the environment.

### Creation of the Composite Image

In step 130, the system compiles all four layers 111, 112, 113, and 114 together into a final composite image 131 showing the user's 2D image 101 with the necessary image manipulation parameters and visualized onto the 3D object with all the appropriate shadows and lighting effects.

### Saving of Composite Images for Review

Once completed, the composite file is viewable to the user through a display 132 utilized by the system at step 140. The composite image 131 is also uploaded for later review, but is not accessible to the user other than for the purpose of viewing through the display utilized by the system. This upload can be to any of the image sources previously discussed above as the system is not exclusive as to a particular method or source for the upload of the composite images 131.

It should be emphasized that the above-described embodiment of the invention is one possible example set forth for a clear understanding of the principles of the invention. Variations and modifications may be made to the above-described embodiment of the invention without departing from the spirit and principles of the invention. All such modifications and variations are intended to be included herein within the scope of the invention and protected by the following claims.

1. A method of creating composite images in real-time comprising the steps of:
uploading a 2-dimensional image for manipulation from a memory source;
applying image manipulations to said 2-dimensional image based on manipulation parameters to produce manipulated 2-dimensional image, said manipulation parameters comprising 3-dimensional affine transformations, projections, cylindrical distortions, or size modifications calculated from a 3-dimensional object image;
aligning said manipulated 2-dimensional image with said 3-dimensional object image;
applying a lighting image layer comprising lighting effects on said 3-dimensional object image;
applying a shadow image layer comprising the corresponding shadows on said 3-dimensional object image; and
creating a composite image comprising said manipulated 2-dimensional image, said 3-dimensional object image, each lighting image layer, and each corresponding shadow image layer.

2. A method of creating composite images in real-time comprising the steps of:
uploading a 2-dimensional image for manipulation from a memory source;
applying image manipulations to said 2-dimensional image based on manipulation parameters to produce manipulated 2-dimensional image, said parameters comprising 3-dimensional affine transformations, projections, cylindrical distortions, or size modifications calculated from a 3-dimensional object image;
aligning said manipulated 2-dimensional image with said 3-dimensional object image; and
creating a composite image comprising said manipulated 2-dimensional image and said 3-dimensional object image.

3. The method of claim 2, further comprising the steps of:
applying a lighting image layer comprising lighting effects on said 3-dimensional object image;
applying a shadow image layer comprising the corresponding shadows on said 3-dimensional object image; and
creating a composite image comprising said manipulated 2-dimensional image, said 3-dimensional object image, each lighting image layer, and each shadow image layer.

4. The method of claim 1, wherein the 2-dimensional image is uploaded from an image-capture device connected to a mobile phone.

5. (canceled)

6. A real time image composite system comprising:
a computer processor configured to receive a 2-dimensional image for manipulation from a memory source, a 3-dimensional object image, a lighting image layer comprising lighting effects on said 3-dimensional object image, and a shadow image layer comprising the corresponding shadows on said 3-dimensional object image; and
a rendering engine comprising various image manipulation parameters to said 2-dimensional image, said parameters comprising 3-dimensional affine transformations, projections, cylindrical distortions, and size modifications calculated from a 3-dimensional object image wherein said rendering engine applies the various image manipulation parameters to said 2-dimensional image and creates a composite of said manipulated 2-dimensional image with said 3-dimensional object image, said lighting image layer, and said shadow image layer.

7. A real time image composite system comprising:
a computer processor configured to receive a 2-dimensional image for manipulation from a memory source, and a 3-dimensional object image; and
a rendering engine comprising various image manipulation parameters to said 2-dimensional image, said parameters comprising 3-dimensional affine transformations, projections, cylindrical distortions, and size modifications calculated from a 3-dimensional object image wherein said rendering engine applies the various image manipulation parameters to said 2-dimensional image and creates a composite of said manipulated 2-dimensional image with said 3-dimensional object image.

8. The system of claim 7, wherein the computer processor is configured to further receive:
a lighting image layer comprising lighting effects on said 3-dimensional object image; and
a shadow image layer comprising the corresponding shadows on said 3-dimensional object image;
wherein the rendering engine creates a composite of said manipulated 2-dimensional image with said 3-dimensional object image, said lighting image layer, and said shadow image layer.
